(19) United States
(12) Patent Application Publication
(10) Pub. No.: US 2009/0278408 A1
(43) Pub. Date: Nov. 12, 2009

(54) INTEGRATED DC POWER SYSTEM WITH ONE OR MORE FUEL CELLS

(76) Inventor: Alfonso J. Cioffi, Murphy, TX (US)

Correspondence Address: CARR LLP, 670 FOUNDERS SQUARE, 900 JACKSON STREET, DALLAS, TX, 75202, US

(21) Appl. No.: 12/436,653

(22) Filed: May 6, 2009

Related U.S. Application Data
(60) Provisional application No. 61/050,756, filed on May 6, 2008.

(51) Int. Cl. H02J 1/00

(52) U.S. Cl. 307/80

(57) ABSTRACT

A power system has at least an AC power source, a DC power source, a transfer switch, at least one AC-DC rectifier, and a power distribution frame. The transfer switch is coupled to the AC power source and the DC power source. The at least one AC-DC rectifier is coupled to the transfer switch and has a boost regulator. A power distribution frame is coupled to the AC-DC rectifier.

A method of switching from an AC power source to a DC power source includes at least isolating the AC source from an input of at least one AC-DC rectifier, connecting the DC source to the input, and sending a signal to a boost regulator of the rectifier to switch from power factor correction operation to fuel cell operation. In fuel cell operation the output of the DC source is matched by the boost regulator.

### CROSS-REFERENCE TO RELATED APPLICATIONS

This application relates to, and claims the benefit of the filing date of, co-pending U.S. provisional patent application Ser. No. 61/050,756 entitled INTEGRATED DC POWER SYSTEM WITH ONE OR MORE FUEL CELLS, filed May 6, 2008, the entire contents of which are incorporated herein by reference for all purposes.

### TECHNICAL FIELD

The present invention relates to electric power systems and, more particularly, to electric power systems having one or more DC electric power sources.

### BACKGROUND

Generally, power and battery plants, or other related power systems, utilize a common voltage bus to provide seamless, uninterrupted power during periods of commercial AC outage. Referring to FIG. 1, power system 100 is an example of a conventional power system using AC generator back-up. Power system 100 may include commercial AC power source 102, back-up AC generator 104, transfer switch 106, AC-DC rectifiers 108, voltage bus 110, batteries 112, and power distribution frame 114.

Commercial AC power source 102 may be coupled to transfer switch 106. Commercial power source 102 may provide power to power system 100. Back-up AC generator 104 may be coupled to transfer switch 106. Back-up AC generator 104 may provide power to power system 100. Transfer switch 106 may be coupled to AC-DC rectifiers 108. Transfer switch 106 may determine whether power from commercial AC power source 102 or power from back-up AC generator 104 is transferred to the AC-DC rectifiers.

AC-DC rectifiers 108 may be coupled to voltage bus 110. AC-DC rectifiers 108 may convert an AC voltage from transfer switch 106 to a DC voltage for voltage bus 110. Batteries 112 may be coupled to voltage bus 110. Batteries 110 may provide short-term power for power system 110. Batteries 110 may be used when, for example, transfer switch 106 switches from one power source to another. Voltage bus 110 is coupled to AC-DC rectifiers 108, batteries 112, and power distribution frame 114. Voltage bus 110 provides power from either AC-DC rectifiers 108 or the batteries 112 to the power distribution frame 114. Power distribution frame 114 is coupled to loads for power system 100, which are not depicted. Power distribution frame 114 distributes power to the loads. A system controller, which is not depicted, may control the operations of power system 100. These operations may include the operation of transfer switch 106.

Normally, commercial AC power source 102 provides power in power system 100 and is the primary source of power in power system 100. During a period of power outage in commercial AC power source 102, batteries 112 generally provide back-up power in the short term. Back-up AC generator 104 generally provides back-up power through transfer switch 106 in the long term. Generally, devices connected to voltage bus 110 may need to exhibit near ideal voltage source characteristics (over a certain range of operation at least) to achieve proper performance.

Fuel cells can supplant an AC generator as a back-up power source. Unlike AC generators, fuel cells produce a DC output voltage. Therefore, a fuel cell may be connected to a DC voltage bus such as voltage bus 110. However, conventional fuel cells generally do not produce a DC output voltage over a narrow enough range to comply with most general power system DC voltage bus specifications. Additionally, conventional fuel cells generally do not possess the required voltage source characteristics suitable for direct connection to a DC voltage bus.

Because the output characteristic of conventional fuel cells is typically non-ideal, conventional fuel cells require energy conversion to couple their energy to a DC voltage bus. Accordingly, a conventional power system using a fuel cell as a back-up power source may require a specialized DC-DC converter that implements various methods, such as an energy matching algorithm, to properly couple the fuel cell output, as load and bus conditions change.

Referring to FIG. 2, power system 200 is an example of a conventional power system using fuel cell back-up. Similar to power system 100, power system 200 may include a system controller, which is not depicted. Power system 200 may include commercial AC power source 102, AC-DC rectifiers 108, voltage bus 110, batteries 112, and power distribution frame 114 arranged similarly to the arrangement of those parts in power system 100. However, power system 200 does not include back-up AC generator 104 or transfer switch 106. Commercial AC power source 102 is coupled directly to rectifiers 108, instead of via transfer switch 106.

Unlike power system 100, power system 200 includes fuel cell 202 and DC-DC converter 204. Fuel cell 202 generally provides back-up power for power system 200 in the long term. Because of the non-ideal output characteristic of fuel cell 202, fuel cell 202 is coupled to DC-DC converter 204. DC-DC converter 204 is coupled to voltage bus 110. The use of DC-DC converter 204 properly couples the output of fuel cell 202 to voltage bus 110.

The use of a DC-DC converter such as DC-DC converter 204 in a power system such as power system 200 may cause several problems. First, a DC-DC converter may add cost to the power system. Second, the DC-DC converter may reduce the efficiency of the power system and increase power loss. Third, the DC-DC converter may add weight and increase the size of the overall solution. Fourth, the additional losses of the DC-DC converter may require the storage of extra fuel, such as hydrogen, used by the fuel cell to produce power. The extra storage increases the size and/or decreases the reserve time of the power system. Fifth, extra cooling may be required to compensate for the additional losses of the DC-DC converter. The extra cooling may increase the size, initial costs, operating costs, and energy usage of the overall solution. Sixth, a custom designed DC-DC converter that implements a special impedance matching function with a very wide input operating range is typically necessary. Readily available off-the-shelf DC-DC converters may not be suitable for various power system applications, thereby complicating the commercial availability of such devices.

Thus, a need exists for a power system which may use one or more fuel cells for back-up power but does not require a DC-DC converter.

### SUMMARY OF INVENTION

Accordingly, a power system is provided in one exemplary embodiment of the present invention. The power system has at least an AC power source, a DC power source, a transfer switch, at least one AC-DC rectifier, and a power distribution frame. The transfer switch is coupled to the AC power source and the DC power source. The at least one AC-DC rectifier is coupled to the transfer switch and has a boost regulator. A power distribution frame is coupled to the AC-DC rectifier.

A method of switching from an AC power source to a DC power source is provided in another exemplary embodiment of the present invention. The method includes at least isolating an AC power source from an input of at least one AC-DC rectifier, connecting a DC power source to the input of the at least one AC-DC rectifier, and sending a signal to a boost regulator of the AC-DC rectifier to switch from a power factor correction mode of operation to a fuel cell mode of operation. In the fuel cell mode of operation the output of the DC power source is matched by the boost regulator.

### DESCRIPTION OF DRAWINGS

For a more complete understanding of the present invention and the advantages thereof, reference is now made to the following Detailed Description taken in conjunction with the accompanying drawings, in which:

FIG. 1 is a diagram of an example embodiment of a conventional power system using AC generator back-up.

FIG. 2 is a diagram of an example embodiment of a conventional power system using fuel cell back-up.

FIG. 3 is a diagram of an integrated fuel cell and rectifier architecture with a fuel cell in accordance with an exemplary embodiment of the present invention.

FIG. 4 is a diagram of an integrated fuel cells and rectifier architecture with multiple fuel cells in accordance with an exemplary embodiment of the present invention.

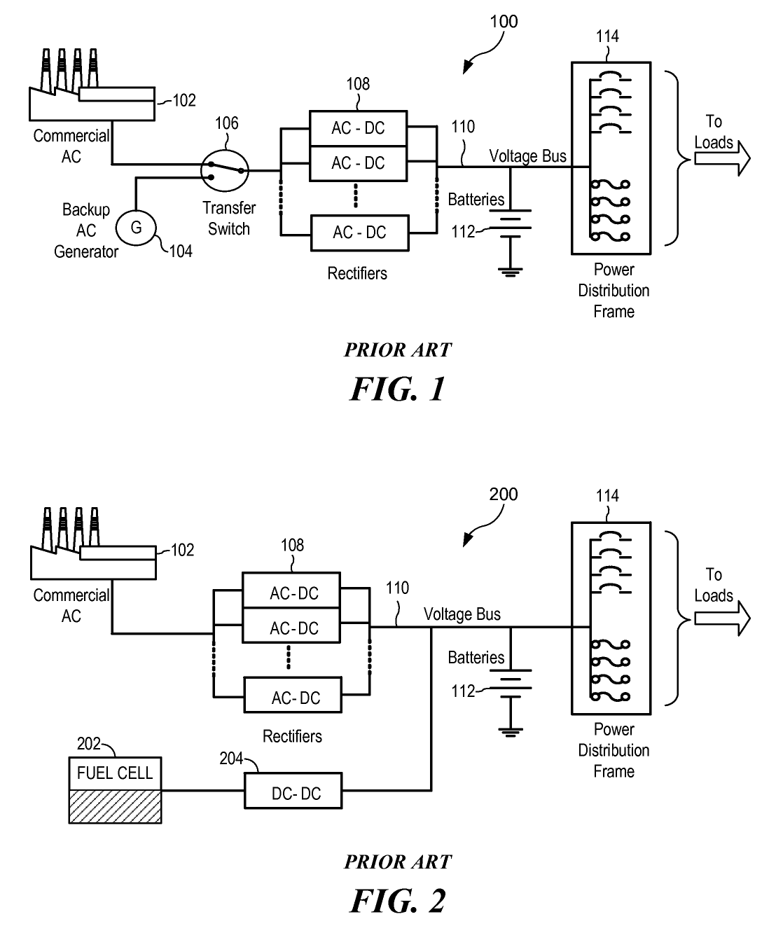

### DETAILED DESCRIPTION OF THE INVENTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, specific details, and the like have been omitted inasmuch as such details are not considered necessary to obtain a complete understanding of the present invention, and are considered to be within the understanding of persons of ordinary skill in the relevant art.

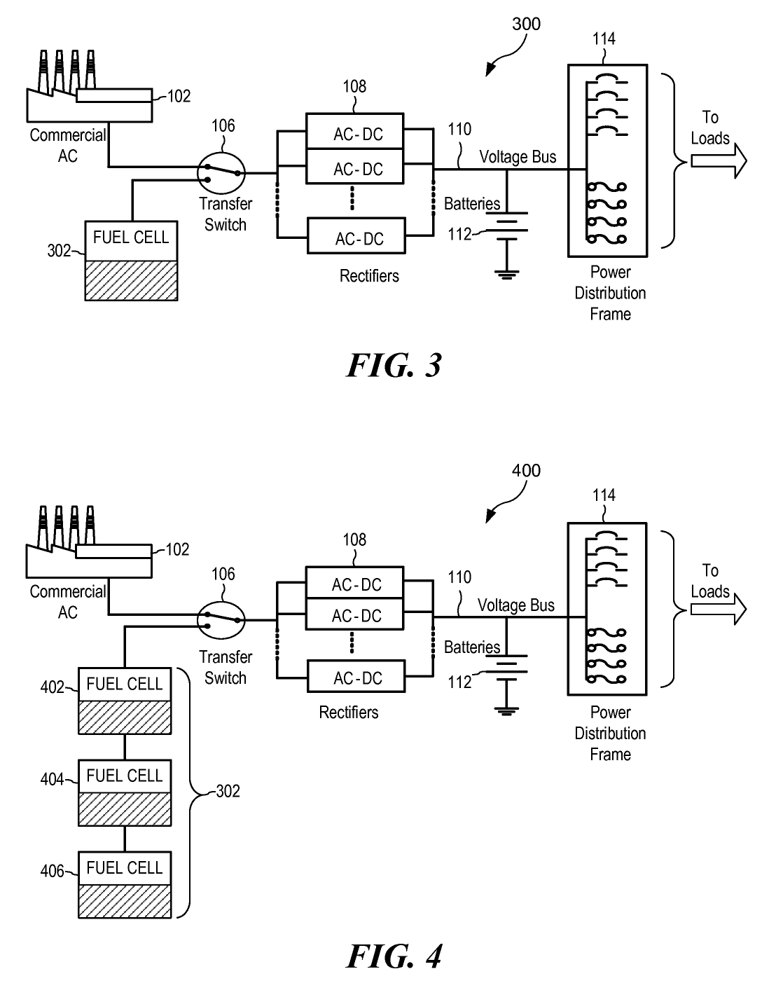

Referring to FIG. 3, power system 300 is a power system in accordance with an exemplary embodiment of the present invention. Power system 300 includes commercial AC power source 102, transfer switch 106, AC-DC rectifiers 108, voltage bus 110, batteries 112, and power distribution frame 114 arranged similarly to the arrangement of those parts in power system 100. However, instead of back-up AC generator 104, power system 300 includes fuel cell 302.

AC-DC rectifiers 108 may utilize a boost regulator to interface to the AC-DC line. A boost regulator is an integral part of conventional AC-DC rectifiers. A boost regulator may also be referred to as a front end converter, a boost converter, a Power Factor Correction (“PFC”) converter, or a boost “front end” of a rectifier.

The boost regulator may allow AC-DC rectifiers 108 to operate over a wide range of input voltages. This range of input voltages may be similar to the range of voltages produced by a fuel cell such as fuel cell 302. The boost regulator may also operate with a DC input voltage of suitable magnitude. A boost regulator may normally operate equally well from a DC source as an AC source because it may have a rectifier bridge on the input side.

Fuel cell 302 may behave like a current source, with variable voltage. The variable voltage of fuel cell 302 is the reason why DC-DC converter 204 was necessary in power system 200. Because a boost regulator may be able to tolerate wide variations in the input voltage, fuel cell 302 may be the input for the boost regulator of AC-DC rectifiers 108.

The boost regulator of AC-DC rectifiers 108 may already implement a specialized input matching function known widely as Power Factor Correction (“PFC”). However, alternatively and/or additionally, other input matching functions known to one of skill in the art may be utilized.

Fuel cell 302 may naturally produce a voltage range within the limits of AC-DC rectifiers 108, which may be conventional rectifier circuits. Referring to FIG. 4, power system 400 is a power system in accordance with an exemplary embodiment of the present invention. Power system 400 is identical to power system 300, except that power system 400 shows that fuel cell 302 may be three fuel cells 402, 404, and 406. Fuel cells 402, 404, and 406 may be deployed in series to create a higher DC output range, similar to stacking batteries to create higher voltages.

The output of fuel cell 302 may be coupled to the input of AC-DC rectifiers 108 through transfer switch 106. Transfer switch 106 may be similar in operation to a common “static transfer switch” widely deployed in back-up generator interfaces of an electrical utility resource. In one embodiment, when AC power source 102 fails, batteries 112 on voltage bus 110 may instantaneously provide back-up power. According to a predetermined algorithm, usually based on the duration of the outage of AC power source 102 or the status of the battery reserve of batteries 112, fuel cell 302 may start up and, after a suitable initiation time, begin producing energy.

In one embodiment, during a period of power outage in commercial AC power source 102 in power systems 300 or 400, the system controller may command transfer switch 106 to change state and perform one or more functions. These functions may include isolating the input from commercial AC power source 102 from the input to AC-DC rectifiers 108. These functions may include connecting the output from fuel cell 302 to the input to AC-DC rectifiers 108. These functions may include sending a signal to the boost regulator of AC-DC rectifiers 108 to switch from Power Factor Correction (“PFC”) operation to Fuel Cell Operation (“FCO”). In Fuel Cell Operation (“FCO”) the impedance of the output of fuel cell 302 may be matched by the boost regulator. These functions may include other functions known to one of ordinary skill in the art.

Following the performance of these functions by the system controller, power generated by fuel cell 302 in power system 300 or power generated by fuel cells 402, 404, and 406 in power system 400 may then be coupled to voltage bus 110. The power may be coupled to voltage bus 110 via AC-DC rectifiers 108. AC-DC rectifiers 108 may otherwise provide power during normal operation.

When power in commercial AC power source 102 is restored, the system controller may then issue various commands such that one or more of the events in the following sequence of events may generally occur. Fuel cell 302 may cease operation and cease to supply power. This event in turn may cause AC-DC rectifiers 108 to stop supplying energy and for batteries 112 to instantaneously provide power to the load. Transfer switch 106 may change state, disconnecting fuel cell 302 from the input to AC-DC rectifiers 108. At this point, since substantially no DC current is flowing from fuel cell 302, transfer switch 106 may open without needing to extinguish or “break” a DC current arc. Therefore, readily available transfer switches may be used as transfer switch 106. Through the occurrence of these events, normal operation may be thereby restored. The system controller may issue other commands known to one of ordinary skill in the art.

The elimination of a dedicated DC-DC converter provides for improvement of various attributes of a power system. These attributes may include cost, space, weight, heat dissipation, and reliability. Other related benefits may be apparent to one of ordinary skill in the art. While power flowing from fuel cell 302 through AC-DC rectifiers 108 may cause some power loss, the use of AC-DC rectifiers 108 may be at least slightly more efficient than the use of DC-DC converter 204 in power system 200.

The utilization of existing rectifier components and existing static transfer switches provides for improvement of various attributes of a power system. These attributes may include the use of existing or familiar supply chains, reduced cost, and improved reliability. Other related benefits may be apparent to one of ordinary skill in the art.

Reduced power loss may be another benefit of the present invention. In the present invention power from the fuel cell may be coupled at higher voltages. Coupling of power from the fuel cell at higher voltages may reduce power loss.

The operations of the system controllers of power systems 100, 200, 300, and 400 may be implemented in stored software or other storage means that will be apparent to those of ordinary skill in the art. These operations may be performed in either hardware or as software instructions for enabling a computer to perform predetermined operations, where the software instructions are embodied on a tangible computer readable storage medium, such as RAM, a hard drive, flash memory or other type of computer readable storage medium known to a person of ordinary skill in the art. In certain embodiments, the predetermined operations of the computer are performed by a processor such as a computer or an electronic data processor in accordance with code such as computer program code, software, and, in some embodiments, integrated circuits that are coded to perform such functions.

Fuel Cell Operation (“FCO”) mode may be implemented in stored software or other storage means that will be apparent to those of ordinary skill in the art. Fuel Cell Operation (“FCO”) mode may be performed in either hardware or as software instructions for enabling a computer to perform predetermined operations, where the software instructions are embodied on a tangible computer readable storage medium, such as RAM, a hard drive, flash memory or other type of computer readable storage medium known to a person of ordinary skill in the art. In certain embodiments, the predetermined operations of the computer are performed by a processor such as a computer or an electronic data processor in accordance with code such as computer program code, software, and, in some embodiments, integrated circuits that are coded to perform such functions.

Various energy sources may be used in place of commercial AC power source 102, fuel cell 302, and fuel cells 402, 404, and 406. For instance, wind power, solar power, biological power, or other fossil fuels may be used. Various configurations and/or architectures known to those of ordinary skill in the art may provide further benefits. Various system control methodologies, in hardware and/or software known to those of ordinary skill in the art may provide further benefits.

Having thus described the present invention in various embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of various embodiments.

I Claim:

1. A power system comprising:
an AC power source;
a DC power source;
a transfer switch coupled to the AC power source and the DC power source;
at least one AC-DC rectifier coupled to the transfer switch, the at least one AC-DC rectifier having a boost regulator; and
a power distribution frame coupled to the at least one AC-DC rectifier.

2. The power system of claim 1, further comprising an at least one battery coupled to the power distribution frame.

3. The power system of claim 1, wherein the DC power source comprises a fuel cell.

4. The power system of claim 1, wherein the DC power source comprises a plurality of fuel cells arranged in series.

5. The power system of claim 1, wherein the DC power source produces a voltage within a range of input voltages of the boost regulator.

6. The power system of claim 1, wherein the transfer switch is at least configured to isolate the AC power source from an input of the at least one AC-DC rectifier and connect the DC power source output to the input of the at least one AC-DC rectifier.

7. The power system of claim 6, wherein the transfer switch is further configured to send a signal to the boost regulator to switch from a power factor correction mode of operation to a fuel cell mode of operation, wherein the boost regulator matches the impedance of the output of the DC power source in the fuel cell mode of operation.

8. A method of switching from an AC power source to a DC power source comprising:
isolating an AC power source from an input of an at least one AC-DC rectifier;
connecting a DC power source to the input of the at least one AC-DC rectifier;
sending a signal to a boost regulator of the AC-DC rectifier to switch from a power factor correction mode of operation to a fuel cell mode of operation, wherein the output of the DC power source is matched by the boost regulator in the fuel cell mode of operation.

9. The method of claim 8, further comprising providing power from an at least one battery.

10. The method of claim 8, wherein the DC power source comprises a fuel cell.

11. The method of claim 8, wherein the DC power source comprises a plurality of fuel cells arranged in series.

12. The method of claim 8, wherein the DC power source produces a voltage within a range of input voltages of the boost regulator.
